(19) United States
(12) Patent Application Publication
(10) Pub. No.: US 2009/0204583 A1
(43) Pub. Date: Aug. 13, 2009

(54) METHOD FOR PROVIDING ACCESS TO DATA STORED IN A DATABASE TO AN APPLICATION

(75) Inventors: Eberhard Hechler, Sindelfingen (DE); Martin Oberhofer, Bondorf (DE); Holger Seubert, Leinfelden-Echterdingen (DE)

Correspondence Address: LAW OFFICE OF DONALD L. WENSKAY, P.O. Box 7206, Rancho Santa Fe, CA, 92067, US

(73) Assignee: International Business Machines Corporation, Armonk, NY (US)

(21) Appl. No.: 12/303,531

(22) PCT Filed: Apr. 5, 2007
(86) PCT No.: PCT/EP2007/053374

§ 371 Date: Dec. 4, 2008

(30) Foreign Application Priority Data
Jun. 8, 2006 (EP) 06115174.2

(51) Int. Cl. G06F 17/30

(52) U.S. Cl. 707/3; 707/1; 707/E17.001; 707/E17.044; 707/E17.005; 707/200; 707/E17.014

(57) ABSTRACT

Access to data stored in a database within a data processing system is provided to an application in the following manner. At least one criterion for providing data is determined based at least on a service level agreement. A provisioning and deployment description identifying at least data units of a database to be provided to the application is received, and a system description including status and resource usage information of possible target systems within the data processing system is maintained. A placement technology description describing properties of data placement technologies is received. At least one target system and at least one data placement technology are selected based on said at least one criterion and said descriptions. Access to said data units is provided for said application using said selected at least one target database system and said at least one data placement technology.

### BACKGROUND OF THE INVENTION

1. Field of the Invention

The present invention relates in general to providing access to data stored in a database to an application. In more particular, but not exclusively, the present invention relates to optimization techniques applied in the area of dynamic data provisioning for applications.

2. Description of the Related Art

There are a large number of applications needing access to data stored in databases. Access to data managed in a database system is first discussed here with reference to FIG. 1, which shows schematically a database system 100. An application 110 has access to the data managed in the database system 100 by sending queries 112. Each individual query issued by the application 110 is analysed and executed separately in the database system 100. After parsing a query by a parser 101, an access plan for the query 112 is processed by a database optimizer component 102 for determining an optimal way to provide the data to the application 110.

The query optimizer 102 develops possible access plans for the data query 112 and determines which data access plan is most efficient, usually in terms of time. Thereby, time related costs are generally used in a cost based optimizer 102 to estimate runtime costs of queries 112 in terms of number of I/O operations required to a buffer 108 or a back-end storage 106, CPU requirements of the database system 100, other resource consumptions, and previously collected statistical information. Having chosen the most efficient path for serving a query, the storage manager component 104 is used to return the data 114 from the database backend storage 106 or alternatively the buffer 108 is accessed, as determined by the database optimizer component 102. Optimization of how to provide the requested data to the application 110 is carried out separately for each query in the optimizer component 102. This optimization is often called SQL optimization.

A database system 100 may contain several servers for storing data managed in the database. In other words, referring to FIG. 1, the backend storage 106 may be distributed among geographically decentralized database systems. Constituent databases are interconnected via a computer network. The constituent database systems remain autonomous, and these multiple autonomous constituent database systems are transparently integrated into a single federated database. For query optimization, the federated database system needs to be able to deconstruct the query into sub queries for submission to the relevant constituent heterogeneous database systems. This involves a more complex cost based query optimization which is called federated query optimization.

The description above relates to a query based optimization for accessing data. A second context for data access optimization relates to placing data on storage nodes in a distributed storage system. As an example, consider the US patent application 20050097285 disclosing a method of determining and instantiating an optimal data placement in a distributed storage system consisting of several nodes for storing data. The question addressed therein is by which data placement heuristic data objects should be placed on storage nodes of a distributed storage system within defined performance requirements and cost requirements.

Storage based provisioning is just one of several different data placement technologies. There is a need for a method for orchestrating different available placement techniques in an efficient way according to defined criteria.

Moreover, applications 110 accessing data in databases and associated possible modifications to the software in a database system 100 are typically developed and tested on dedicated test systems before installation on a production system. Developing and testing—and finally installation of applications with a proper use of production database systems—involve many steps that need to be done manually.

There is thus a need for a solution for providing access to data managed in a database for an application in an environment, where applications may access data in various databases and where developing and testing capabilities may be needed. Furthermore, there may be a need to take into account further requirements (such as requirements related to data access performance, cost or system outage) associated with the application.

### SUMMARY OF THE INVENTION

A first aspect of the present invention provides a computerized method for providing data stored in a database within a data processing system to an application, the method comprising determining at least one criterion for providing data to the application from the data processing system based at least on a service level agreement; receiving a provisioning and deployment description identifying at least data units of a database to be provided to the application; maintaining a system description including status and resource usage information of a plurality of possible target systems within the data processing system; receiving a placement technology description describing properties of a plurality of data placement technologies supported within the data processing system; selecting at least one target system and at least one data placement technology based on said at least one criterion, said provisioning and deployment description, said system description and said placement technology description; and providing access to said data units for said application using said selected at least one target database system and said at least one data placement technology.

The method may further comprise using the selected at least one data placement technology to deploy the data units to said selected at least one target system. This step may be absent, for example, if the selected data placement technology is direct read of data already stored in a database.

The provisioning and deployment description may further identify at least one application unit executable by said database and associated with said data units, and said method may comprise providing access to said at least one application unit for said application. These features are needed, when an application needs access to some functionality (that is, application units) associated with the data in addition to access to the data itself.

The method may comprise deploying said at least one application unit to said selected at least one database system. It is possible that different application units are deployed using different deployment techniques.

The method may comprise storing said at least one application unit in an application deployment archive together with said provisioning and deployment description. The application deployment archive facilitates coordination of possible various versions of the application units that may relate to different applications needing access to the same data. The method may further comprise receiving an updated version of an application unit associated with said application, storing said updated version in the application deployment archive, and updating said provisioning and deployment description to refer to the updated version of the application unit.

In the method, said at least one application unit may comprise at least one of the following: computer executable code in compiled form, and computer executable code in source form. Some examples of the computer executable code in source form are stored procedures, user defined functions, and triggers.

The method may further comprise receiving a logical name of an application unit from said application; binding said logical name to an executable application unit based on said provisioning and deployment description; and executing the deployment of the respective executable application unit in said selected at least one target database system. This late binding allows different applications to call different versions of the application units in a flexible manner and transparently.

In the method, said plurality of data placement technologies may comprise at least one of the following data placement technologies: direct read, materialized query tables, database replication, and storage replication. Direct read refers here to reading of the original source data already stored in a database in the data processing system.

A second aspect of the invention provides a data processing program product for execution in a data processing system, said computer program product comprising software code portions for performing a method as described above when said data processing program product is loaded in said data processing system. The data processing program product may be embodied in a computer readable medium.

A third aspect of the invention provides a data processing system comprising: a plurality of database systems for storing data units; a placement technology description describing properties of a plurality of data placement technologies supported by the data processing system; at least one interface for receiving service level agreements associated with applications, and provisioning and deployment descriptions identifying at least data units associated with respective application units, and a controller configured to carry out a method as defined above for providing access to data stored within the data processing system to an application.

The data processing system may comprise at least one server for running said applications. Said provisioning and deployment description may identify application units associated with respective applications, and the data processing system may comprise storage facilities for storing said application units executable by said database systems.

In the data processing system, said controller may comprise a data processing program installed on the data processing system.

### BRIEF DESCRIPTION OF THE DRAWINGS

The present invention is illustrated by way of example, and not by the way of limitation, in the figures of the accompanying drawings in which:

FIG. 1 shows schematically query optimization in a known database system;

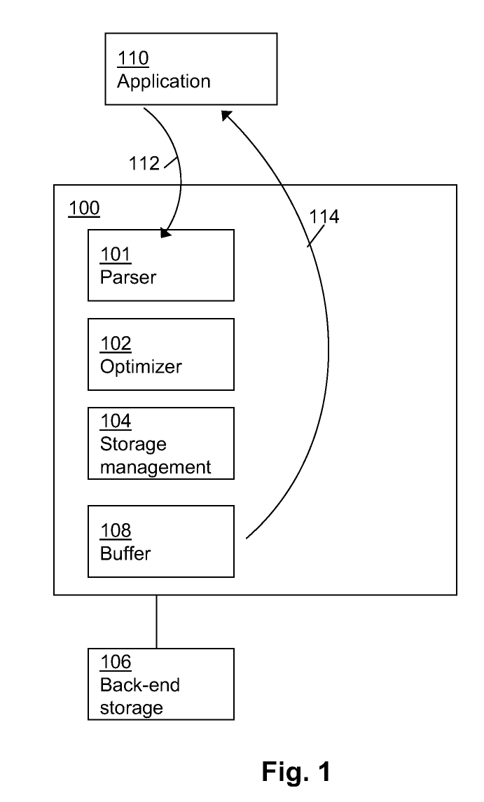

FIG. 2 shows schematically a data processing system where embodiments of the invention are applicable;

FIG. 3 shows schematically, as an example, the top level architecture of a detailed embodiment (GIPDO) of the invention;

FIG. 4 shows schematically two core components of the detailed embodiment of the invention;

FIG. 5 shows schematically the structure of an application deployment archive for embodiments of the invention;

FIG. 6 shows schematically an example application deployment archive for initial deployment;

FIG. 7 shows schematically how the detailed embodiment (GIPDO) interacts with other components in a dynamic infrastructure;

FIG. 8 shows schematically, as an example, optimizer functionality of the information provisioning unit;

FIG. 9 shows schematically, as an example, detailed optimization steps when database replication technology is considered as placement technology by the information provisioning unit;

FIG. 10 shows schematically a further example of an application deployment archive, and

FIG. 11 shows schematically the concept of the late binding and namespace resolution.

### DESCRIPTION OF EMBODIMENTS OF THE INVENTION

In the following, embodiments of the invention are described in the context of database systems. A detailed embodiment of this invention is called in the following “Global Information Provisioning and Deployment Optimizer (GIPDO)”. Features discussed in connection with the detailed embodiment are applicable also to other embodiments of the invention.

### DEFINITIONS

Embodiments of the invention are applicable on a data processing system, which contains at least one database system and an implementation of this invention. A database system is a system containing at least one computer (typically called a server) and suitable storage means, and the database system manages at least one database. In the data processing system, more than one database systems may be using same servers and storage means. The term “application” in the following description refers to an application, for example a web service, accessing data in a database.

In the following description, the term “data unit” refers to an embodiment of an entity in the database. The actual embodiment depends on how the database system models and represents data. For example, in a relational database system, a data unit could be rows within a table, a table or a corresponding index on a table.

The term “application unit” refers to a program executable by a database system. Examples are—but not limited to—stored procedures (SP), user defined functions (UDF) and triggers. An application unit operates on data units stored in the database system. An application unit might be triggered by an explicit request of an application (for example, SP or UDF) or implicitly by the database (for example, trigger). In both cases, the application units are executed by the database. Note that an application unit refers typically to the portion of logic of an application which is implemented using methods provided by a database server. This means that these application units are part of the overall application for which the data units and the application units are provided by embodiments of the invention, especially by the GIPDO.

The term “deployment of application units” refers to the installation of application units into a database. Depending on the type of application unit, the deployment might require different steps. Triggers for example require only the execution of the appropriate SQL statement. UDFs and SPs may require more complicated steps depending on the implementation of the database system.

The terms “data placement” and “placing data” refers in the following to methods used to provide data units of a database system to an application for accessing these data units. Data placement, or the placing of data, can be done by different data placement techniques. The term “(data) placement technology” refers to a specific data placement technique having certain characteristics in term of performance and/or data access rights. One example of data placement technique is database replication, allowing read and write operations on data. Another example of data placement technique is using temporary tables in a database system, allowing only read access to the data. Storage based replication, which makes a copy of the data units by hardware means provided by the storage system, is usually faster than database replication. However, these storage devices are more expensive than the means to use database replication. A further example of data placement technology, in addition to database replication and storage based replication, is Materialized Query Tables (MQT). Some data placement techniques, like database replication and storage based replication, transfer data units between a source (the database containing the master version of the data) and a target (a database containing a copy of the data from the source). The source maintaining the “master data” always contains the most actual and accurate data. At specific points in time (for example, on a given date/time, in response to a threshold value, or as defined by a periodic cycle) defined data portions are copied from the source to the target. If, for example, a database replication technology is used, a typical scenario is a source database managed by a database system on a server ‘A’ and a target database managed by database system on a server ‘B’. In order to define and execute the replication, the database replication technology needs to know which tables (or portions of them defined by horizontal and vertical filters) it replicates from the source database to the target database. In addition, the database replication technology need to know if the replication has to be done only once or periodically (the length of this cycle is determined by data accurateness and latency constraints). The term “placement technology information” refers to static information about different placement technologies, such as cost, performance, and/or throughput.

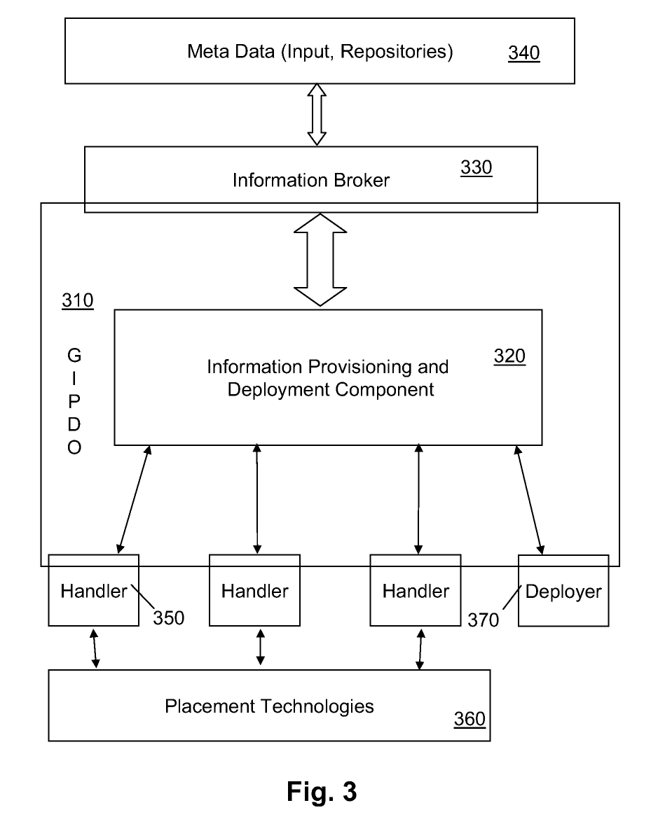

The term “Service Level Agreement” (SLA) refers to a description defining the boundaries of what the system should achieve from a business perspective point of view. It is part of establishing a service subscription. Following is a possible list of criteria of SLAs, which are relevant in the context of information provisioning and deployment: data volume, data accurateness, data latency, data quality, duration for which the data is required (for example, duration of a business process), allowed impact on production system (for example, no impact), cost (for example, maximum cost), resilience specifications (for example, minimum disaster recovery time), and/or operation system related specifications (for example, version of operation system). The fulfillment of these SLA criteria is typically continuously monitored to ensure a complete lifecycle management of the provisioned data units and deployed application units, including its setup, SLA recovery, cleanup and billing. Note embodiments of the invention have functionality (for example, the Information Broker 330 in FIG. 3) to process the SLA in order to extract all critical information related for the optimization. The SLA may contain a high-level set of business-related criteria, which need to be translated into a meaningful set of technical criteria (by the Information Broker 330).

The term “provisioning and deployment” refers to a method for providing data units and related application units to a requester. In other words, it refers to a method on how to store data units and related application units within the data processing system and to provide access to these data units and application units to allow execution of a given business process that is further defined through an SLA. In accordance with embodiments of the invention, this provisioning and deployment is done by orchestrating placement techniques that satisfy different conditions defined by metadata (see definition below). The term “provisioning and deployment description” refers to information identifying at least different data units, maybe also access criteria on the data units and/or references to application units. Furthermore, information about the business process using the data and application units is typically available. The term “data placement descriptor” refers to a subset of information of the “provisioning and deployment description” that is related to information about the individual data units that need to be placed according to the defined (SLA) criteria. The term “application deployment descriptor” refers in the following to a subset of information of the “provisioning and deployment description” that is related to information about individual application units that need to be placed according to the defined (SLA) criteria.

The term “resource usage information” refers in the following to dynamic data of provisioning and deployment target systems such as CPU workload, memory utilization, and disk utilization. The term “hardware status information” refers to data about the overall hardware (for example, servers and storage systems) in the dynamic infrastructure. Each piece can be available or used. Embodiments of the invention interact with this hardware status information by querying it for free resources if there is a need for free resources. And if a resource is selected and deployed, GIPDO triggers to mark the selected resource as used. Consequently, GIPDO also triggers to mark a resource as free again, if the resource is not used any longer.

Note that resource usage information, hardware status information and placement technology information can be stored in metadata repositories which are part of a dynamic infrastructure in accordance with the invention. Such a repository usually has a programmatic interface to access and modify this information.

The term “metadata” refers data that can be found in the following: resource usage information, hardware status information, placement technology information, SLA, and provisioning and deployment description (or application deployment archive). Metadata is not a separate concept; it is used as short hand term for input data typically, but not limited to, consisting of the elements named in the list above. Metadata is all the data GIPDO needs for operation and decision making. For more details please see section “Meta Data Processing”.

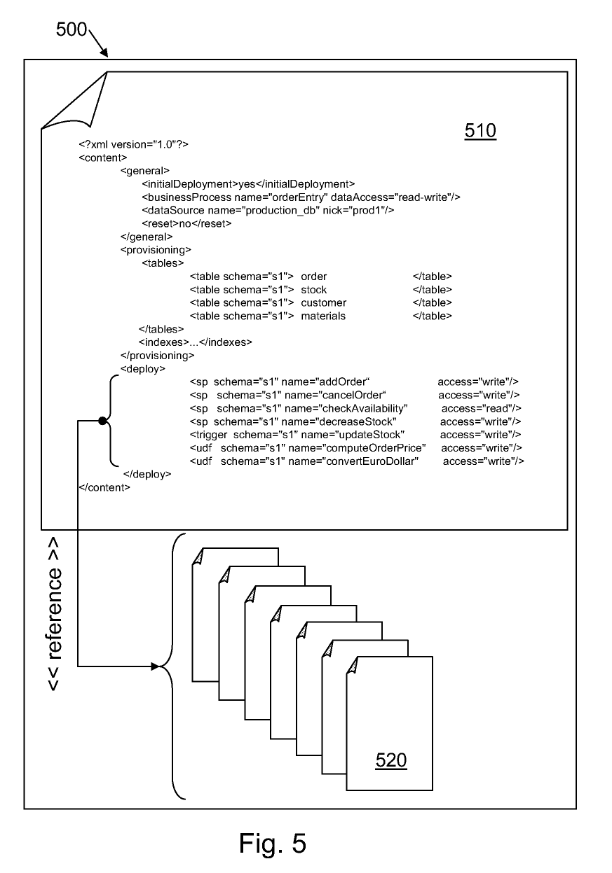

The term “application deployment archive” refers in the following to the provisioning and deployment description with the application unit implementations (source or binary) if applicable. The application unit implementations are referenced from within the provisioning and deployment description by the application deployment descriptor. An example of application deployment archive is shown in FIG. 5, which is discussed briefly below. Note that there might be a case where only data units need to be provided to an application. Obviously, there are no application units to deploy and hence the application deployment archive will only contain the information and deployment description.

### Architecture Overview of the Detailed Embodiment Called GIPDO

The described optimization techniques in “The Description of Related Art” either determine an optimal access plan to data units in a database system for a query being issued against that database system from an application, or an optimal placement of data on different storage nodes. This level of optimization does neither consider orchestration of different data placement techniques, nor the coupling of data units to application units. An efficient information provisioning and deployment strategy, realised by orchestrating different placement technologies, needs to be put into a more global context, taking application units and data units as well as different metadata into consideration. A level of optimization as addressed by today's cost based optimizers is not sufficient in the context of the growing complexity of deploying applications and business processes.

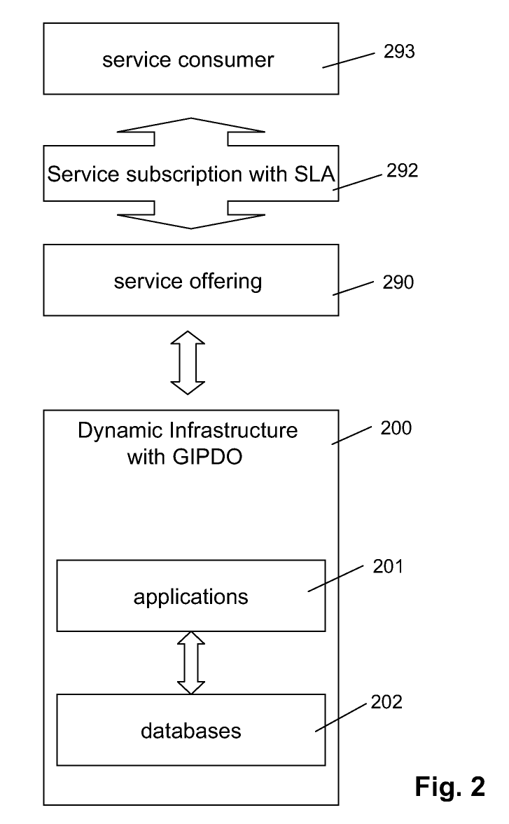

A detailed embodiment of the invention, which is called Global Information Provisioning and Deployment Optimizer (GIPDO), takes into account both the orchestration of different data placement techniques as well as application units that are associated to the data units that need to be placed. GIPDO is part of a dynamic infrastructure 200 as shown in FIG. 2. The dynamic infrastructure 200 is an Information Technology (IT) environment (in other word, a data processing system), where hardware and software are used by applications based on Service Level Agreements (SLAs). A typical scenario, where a dynamic IT infrastructure is used, are companies providing IT hosting. The dynamic infrastructure manages databases 202 used by applications 201 autonomously. The dynamic infrastructure 200 has a service interface, offering hosting services 290. Whenever a service consumer 293 subscribes to the hosting services, an SLA is established for an application, which the consumer would like to have hosted. Based on the subscription 292, the dynamic infrastructure provides the required data units together with the application units working on the corresponding data units to the application. The aim is to host these application units and data units in an efficient, optimized layout in the dynamic infrastructure fulfilling the SLA requirements. Determining this efficient optimized layout is a task which is given to GIPDO by the dynamic infrastructure 200.

In FIG. 3, the architecture of the GIPDO 310 is shown. The core of GIPDO is the Information Provisioning and Deployment Component 320. This component 320 interacts through an Information Broker 330 with metadata 340. Metadata 340 contains and describes the request for making data units and application units available to a service. Once the metadata is processed, the Information Provisioning and Deployment Component 320—which is at its core an optimizer—analyzes the request and suggests a layout of the data units and application units. Based on certain criteria the Information Provisioning and Deployment Component 320 optimizes the request and chooses the most efficient layout. Once this layout is determined, the Information Provisioning and Deployment Component 320 uses a Handler 350 to trigger the placement of the data units with the appropriate placement technology 360. The Handler 350 orchestrates existing placement technologies, which perform the placement of the required data units. Through the Deployer 370, the appropriate deployment actions for the application units are triggered.

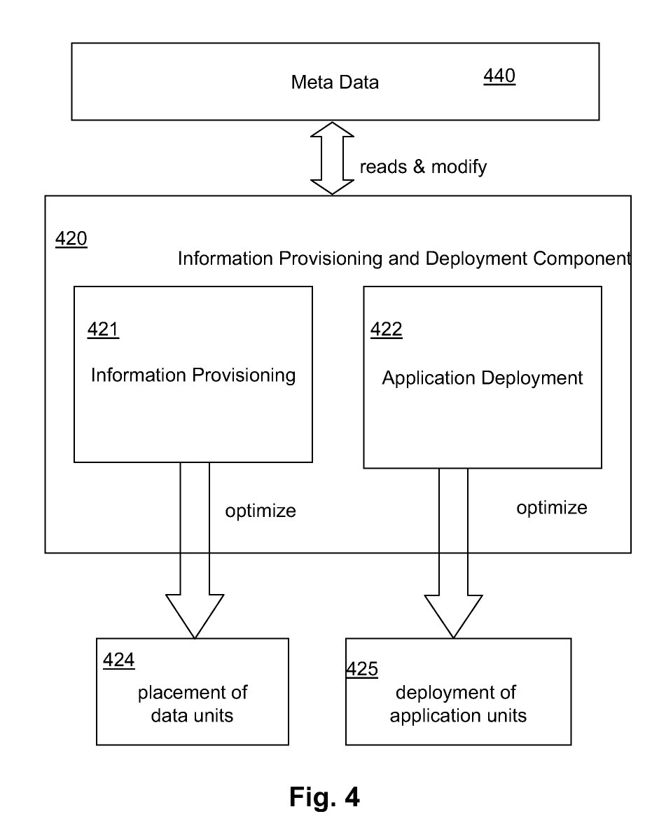

In FIG. 4, the Information Provisioning and Deployment Component 420 is shown in more detail on a conceptual level. The Information Provisioning and Deployment Component 420 interacts by reading and modifying data with metadata 440. Internally, the Information Provisioning and Deployment Component 420 has two parts: the Information Provisioning unit 421 and the Application Deployment unit 422. The Information Provisioning unit 421 optimizes the selection and orchestration of appropriate placement technologies, which in turn do the actual placement 424 of data units. The Application Deployment unit 422 optimizes the deployment 425 of the application units, which belong to and work on the data units.

### Use Cases

Today, many companies outsource their IT infrastructure to large IT system providers. From time to time it is necessary to update an application hosted by the IT system provider. Online stores, for example, can be implemented based on a 3-tier architecture. This usually means a front-end represented by a web browser based GUI (graphical user interface), a web application server as mid-tier, and a database server as backend, which is used for OLTP (Online Transactional Processing). Database application units can be used in this environment for the order entry business process and represent the application part running within the database, whereas the other application part is executed by the web application server.

The first use case within the given online store scenario above would be “Test against production data in OLTP environment using GIPDO”. OLTP applications modify data, for example, by inserting a new order, updating an order that was delivered, or deleting an order that was cancelled. Obviously running the new version of the application for testing purposes against the production database is not desired in such a case. If the production system is outsourced, an embodiment of the present invention can be used to get a subset of the production database replicated to a system where the testing can be done in an automated manner. This use case hence assumes that developers want to test new versions of their application against real production data to see if everything works. The changed application part can be the part executed by the database (meaning the database application units), the application part executed by the web server or both. The focus in this use case will be on new application versions of the database application units. The IT system provider offers to test new application versions against real production data based on given SLAs. This service is subscribed by developers or the development department in order to allow for efficient testing.

Following are the benefits of embodiments of the invention (for example, benefits provided by GIPDO) for this use case, when the service is subscribed through an SLA based subscription. Assignment of required and dedicated administrative IT resources is avoided because there is no manual setup, monitoring, or cleanup. Less administrative IT resources contribute to a reduced total cost of ownership (TCO). Accurate data for testing of new or modified business processes can be offered. With accurate data error detection related to production data structure of a new application or business process is possible before deploying the new application or business process on the production system. Furthermore, improved software quality and less system outages (improved business resilience) can be achieved.

The second use case assumes that the same scenario as above is hosted by the IT system provider for an extended period of time (say six months at least). In this case, as an example, the financial department of the company, which outsourced the IT infrastructure, would like to analyze the online shop results for the last quarter using an Online Analytical Processing (OLAP) scenario. The results should be obtained with no measurable impact on the running production system, and it is sufficient to have the data from the quarter in question available. The data should be available for example for 8 weeks starting from two weeks before the quarter ends and six weeks after the quarter is finished. Again, the IT system provider can offer a service for hosting OLAP.

Following are the benefits of GIPDO (or, more generally, of other embodiments of the invention) for this use case, when the OLAP hosting service is subscribed through an SLA. Assignment of required and dedicated administrative IT system is avoided, and thus TCO is reduced. Lifecycle management of the OLAP service can be automated. It is possible to achieve improved business resiliency based on quality of service (QoS) criteria which are monitored and enforced.

### System Landscape with Embodiment of Invention

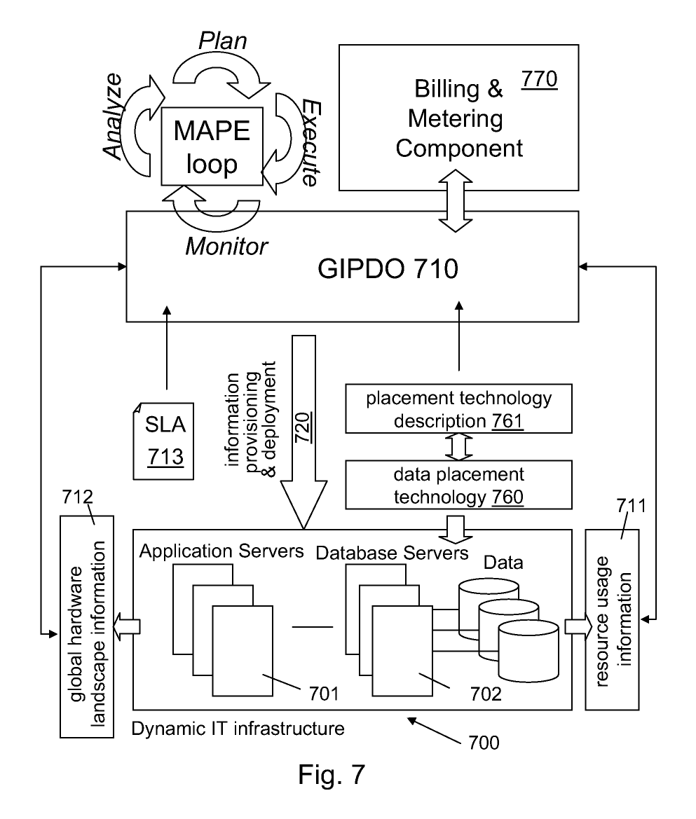

As FIG. 7 shows, a dynamic IT infrastructure 700 manages typically multiple physical servers. On such servers, database servers 702 and web application servers 701 are typically running autonomously. Based on a given SLA 713 the core objective of GIPDO 710 is to determine and execute an efficient provisioning and deployment strategy 720 among servers in the dynamic IT infrastructure. For the execution of the information provisioning and deployment strategy 720, GIPDO orchestrates different placement technologies 760 (corresponds to 424 in FIG. 4) for data units and triggers the necessary deployment steps for associated application units. Data units and associated application units are described and contained in the provisioning and deployment description. Based on meta data (entities 711, 712, 713 and 761 in FIG. 7 show in more detail the entity 340, 440 in FIGS. 3 and 4) from the application deployment descriptor, placement technology description 761, resource usage information 711 and global hardware status information 712, GIPDO determines an efficient information provisioning and deployment strategy (arrow 720), which addresses the needs of the given SLA 713. The core components of GIPDO 710 for provisioning and deployment are the information provisioning unit 421 and the application deployment unit 422. By interacting with monitoring services, GIPDO 710 assures a Monitor-Analyze-Plan-Execute (MAPE) loop, and hence guarantees continuous SLA fulfillment throughout execution. Interaction of GIPDO 710 with metering and billing services 770 allows precise billing operations for providing access to data that is managed in database systems 702. Finally, GIPDO may generate metadata for cleanup based on the duration of the data access period as required according to the SLA. Thus support for lifecycle management for the managed resources in the dynamic IT infrastructure 700 is given by GIPDO 710 as well.

### Metadata Processing

GIPDO accesses metadata through the Information Broker component 330 in FIG. 3. Metadata for GIPDO consists usually of several components, and some or all of the following may be included: Service Level Agreement (SLA) 713, provisioning and deployment description 510, resource usage information 711, hardware status information 712, and placement technology description 761.

However, the details of how the metadata are represented, stored, accessed and modified are hidden by the Information Broker 330 for GIPDO. The Information Broker 330 has two core functions on behalf of the Information Provisioning and Deployment Component (see FIG. 4): translating business terms of an SLA to technical terms (for example, business resilience criteria) and interacting with external metadata. Some examples of the interaction with external metadata are the following: marking an available server as used if needed for a target system; marking an used server as free if not needed any longer; and/or reading the provisioning and deployment description 510 in order to be able to provide appropriate subsets of this information as a data placement descriptor 512 to the Information Provisioning component 421 (see FIG. 4) and as an application deployment descriptor 513 to the Application Deployment component 422.

FIG. 5 shows an example of an application deployment archive 500. The application deployment archive 500 contains a plurality of provisioning and deployment descriptions 510. A provisioning and deployment description 510 typically contains a reference to source or binary files of relevant application units. As FIG. 5 shows, these source and/or binary files 520 are typically also included in the application deployment archive.

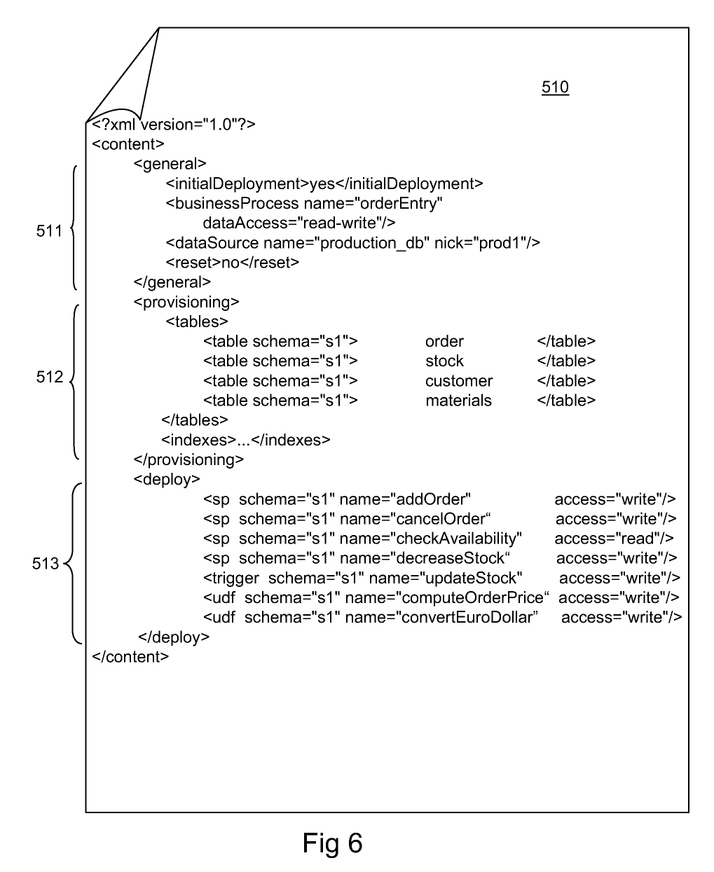

FIG. 6 shows more details about the contents of the provisioning and deployment description 510, which is an XML document by the way of an example. The provisioning and deployment description 510 includes general information 511, a data placement description 512 and an application deployment description 513. Note that the choice of using an XML file is an implementation detail, and it is possible to use any other format understood by the information broker 330 in FIG. 3 as well.

### Optimization Performed by the Information Provisioning Unit

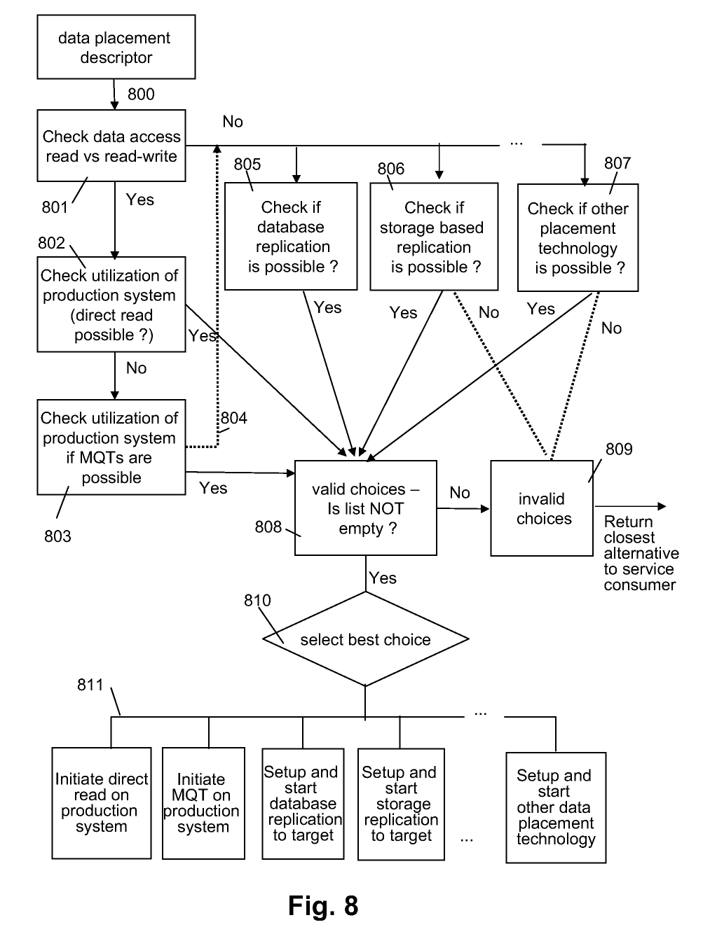

The optimization for best layout regarding the placement of data is computed by the information provisioning unit 421. A conceptual view of how this component works is shown in FIG. 8. When the Information Broker 330 processed the metadata, the subset of the metadata which is the data placement descriptor is given 800 to the information provisioning unit, which then starts the processing. It first determines whether read only or read and write data access is required in step 801. If read and write data access is required, then only placement technologies which are able to provide this kind of data access to data units are considered. If read only access is required, then first the placement technologies providing read only access are evaluated and afterwards in step 804 the placement technologies providing read and write access are evaluated and considered. For evaluating different data placement technologies, a matrix as defined in Table 1 may be used.

The following Table 1 illustrates a set of typical technologies available from multiple database vendors (not necessarily all of them by each individual vendor) with the corresponding top-level attributes:

TABLE 1
Examples of Placement Technology Information.

| | | | | | | High |
|---|---|---|---|---|---|---|
| | MQT | Database | File | Storage | | Availability |
| Technology | (*) | Replication | Replication | Replication | Cloning | (**) |
| additional | No | Yes | Yes | Yes | Yes | Yes |
| hardware | | | | | | |
| (***) | | | | | | |
| data access | Read only | Read-Write | Read-Write | Read-Write | Read-Write | Read-Write |
| Data currency | Medium | Low-High | Low-High | High | low | High |
| | | (schedule!) | (schedule!) | | | |
| impact on | medium | Low | Low | Low | low | Medium |
| production | | | | | | |
| (****) | | | | | | |
| provisioning | short | Medium-long | Medium-long | Short | Medium-long | Medium |
| time | | | | | | |

(*) MQT are aggregated data tables in the production database on the production system and their creation is triggered by the information provisioning unit, if direct reads from the production database would generate too much input and output (IO) operations in the production database. Aggregation means that a reduced amount of data has to be read. In order to have this option available, the information provisioning unit needs to have some knowledge on applicable aggregations for the business process available.
(**) With “high availability”, a hot standby solution is meant. This kind of replication technology would be selected if the maximum disaster recovery time can only be fulfilled with this kind of setup to enhance business resiliency for the production system.
(***) “No” in this row means that the default setup is on the same physical machine. “Yes” in this row means that the default setup is a target system on a seperate physical machine.
(****) This means how the production system (mainly the database) is affected if this replication technology is selected.

If only read access is required, then the information provisioning unit 421 analyzes resource usage information 611. If the information provisioning unit detects that the production system has sufficiently free computing resources with respect to IO, CPU and memory utilization (step 802), then the “data placement” is the ‘trivial placement’, which means the data units can stay where they are. In this case, the trivial placement is added to the list of valid choice. If trivial placement is not possible, the list of invalid choices is updated accordingly. For the sake of simplicity, a corresponding dashed line in FIG. 8 from step 802 to step 809 is omitted.

If only read access is required but the IO, CPU, and/or memory utilization indicates that the load would be too much with a trivial placement, then MQT are considered in step 803. MQTs are aggregated views on data, which means reading from MQTs requires less resources than reading from the underlying—usually much larger—full tables. If the resources required by the MQTs are acceptable based on the resource usage information, this data placement layout is added to the list of valid choices. Otherwise the data placement with MQT is added to the list of invalid choices. For the sake of simplicity, a corresponding dashed line in FIG. 8 from step 803 to step 809 is omitted.

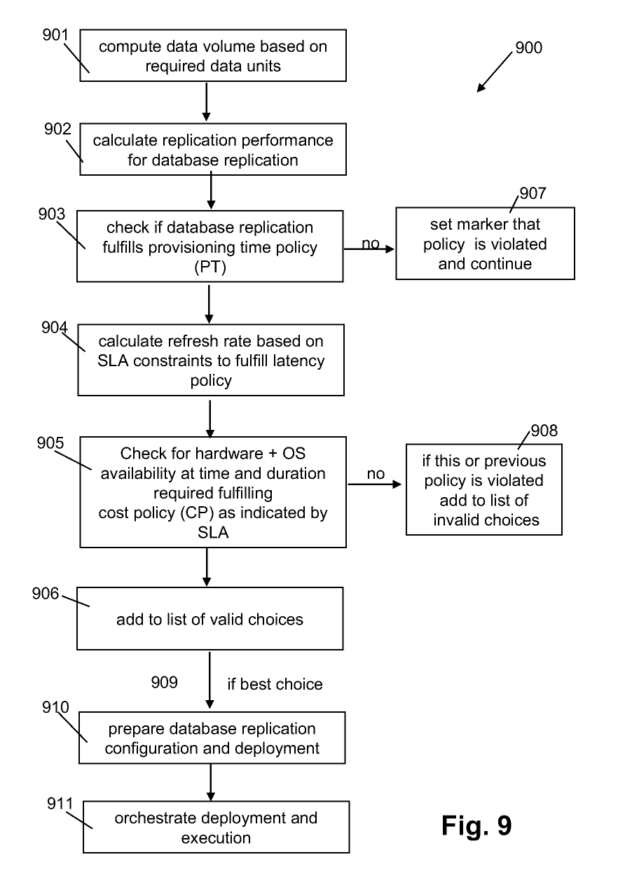

After step 803, all available placement technologies providing read and write access are evaluated subsequently. FIG. 8 shows, as an example, evaluation of database replication in step 805, evaluation of storage based replication in step 806, and evaluation of other technologies (if available) in step 807. For each of these evaluation steps, a series of sub-steps are performed. As an example, details of database replication evaluation (step 805) are conceptually shown in FIG. 9, which is discussed briefly below. Depending on whether a placement technology can fulfil the requirements given by the data placement descriptor, it is either added to the list of valid or invalid choices (steps 808 and 809). If the database replication is an invalid choice, it is added to the list of invalid choices but for the sake of simplicity in the figure a respective dashed line is omitted.

Once the placement technologies have been evaluated in steps 801-807, the information provisioning unit 421 checks if the list of valid choices is empty or not (step 808). If the list is not empty and if there is more than one choice, the best choice is chosen in step 810 and through a handler 350 the corresponding placement technology for the data units is selected and orchestrated in step 811. This step 811 includes the update in the hardware status information triggered by GIPDO to mark used resources for the placement as used (before they were marked free). Note that GIPDO also triggers to mark them as free, if they are not needed anymore. The choice mechanism for selecting the best choice from the list of valid choices in step 810 can optimize, for example, for minimum cost caused by the selected layout for the IT hosting provider. As an example of a feasible optimisation alternative is maximum business resiliency (remember all items in the list of valid choices are fulfilling the constraints implied by the information provisioning descriptor including the cost constraint) for the chosen layout, especially if the customer requesting the service is a customer from a customer group (lets name this group “premium customers”) which is of particularly importance for the IT hosting provider. For the group of premium customers, the IT hosting provider maximizes customer satisfaction by offering them the maximum business resiliency available within the cost constraint (and not necessarily the cheapest solution from his perspective fulfilling all constraints). To consider maximum business resiliency in this optimization step as well for certain customers in order to provide more reliable service to them increases customer satisfaction with the potential drawback of higher costs on the side of the IT hosting provider.

If the list of valid choices is empty in step 808, the closest alternative to the requested service from the list of invalid choices may be returned to the service consumer in step 809. In this case, the service consumer can then choose to subscribe to the service with poorer conditions or leave it the way it is. The closest alternative can be chosen regarding the placement layout with minimal cost for the service consumer, or other criteria depending on implementation details for this optimization step.

For database replication, the check whether or not the placement technology fulfils the constraints implied by the information provisioning descriptor 512 will now be explained in connection with FIG. 9 in more detail. For other placement technologies, conceptually the same process applies and the corresponding details will not be discussed here. The data placement descriptor (for example, information provisioning descriptor 512) contains information, which data units (tables, if applicable with horizontal and vertical filtering; indexes, etc) require data placement. For determining the optimal setup of a database replication, the data volume for the initial replication plays a significant role. Hence the first step 901 in method 900 is to compute the overall amount of data requiring initial replication from a source (usually a production database) to a target (usually a database residing on another server). Based on placement technology information, which contains performance metrics for different setups, possible configurations for the database replication technology for performing the initial replication is computed in step 902. Using them, the provisioning time (PT) policy which is part of the information provisioning descriptor is checked in step 903. Policies like the PT are examples of optimization strategies implemented in the information provisioning unit which is part of GIPDO. These policies apply for the placement technologies. Some of these policies will be described throughout the remaining part of this section and the PT policy will be the first among them. The PT policy is required in order to ensure that the system needed to provide a certain service, is available at the required time specified by the SLA. Hence the information provisioning unit needs to make sure that any selection of placement technologies to provision the data allows having the data units ready when needed. For the provisioning time computation at least the following pieces of information are required: the amount of time available for setup (PT), the transfer rate (TR) for a specific setup of a certain type, and the amount of data which needs to be replicated (AD). PT is computed by subtracting the current time from the time when the system must be ready, and PT is typically measured in minutes. The values for TR are available as part of the placement technology information and the transfer rate is specified per characteristic setup type for each placement technology. TR is typically measured in MB/min. TR depends on the placement technology used in a certain setup. AD is the sum of all data units requiring placement, and AD is typically measured in MB. A placement technology is applicable for fulfilling the PT when AD/TR<PT. In addition for the placement technology the required hardware resources must be free during the time they are required. This information is part of the hardware status information as well. If either AD/TR<PT is violated or required hardware is not available or both, the PT is considered to be broken. Note that the validation regarding costs for the hardware resources is done later as part of the cost policy optimization discussed later. If the PT is fulfilled, the latency policy is evaluated next in step 903. Otherwise a marker is set in step 907 that the database replication as placement technology violates the PT.

Consider an example where 250 GB data should be available in ten hours. Assume the placement technology information for placement technologies provides values for TR as shown in Table 2 “placement technology information” below. In the given example both storage based replication scenarios would be sufficient to fulfil AD/TR<PT constraint when performing the checks for the storage based replication as placement technology. However, the database replication as placement technology would not be able to do it based on the numbers shown below. Next the hardware status information is scanned to see if the required hardware is available for the required time as indicated by the information provisioning descriptor meaning that the resources for possible layouts are free. Note that the validation if they fulfil cost constraints is done later as part of the cost policy. If the required hardware is not available, PT policy would be broken. Note that initial replication configuration might be different compared to the periodic replication setup in case database replication technologies are selected. The latency policy description provides more details for this which will be discussed later.

TABLE 2
Placement Technology Information.

| Replication | Transfer Rate | | | |
|---|---|---|---|---|
| Technology | (TR) in MB/min | Storage | Network | |
| database | 10 | SCSI | 1 | Gigabit Ethernet |
| replication | | | | |
| database | 5 | SCSI | 100 | MBit Ethernet |
| replication | | | | |
| storage based | 500 | ESS | 1 | Gigabit Ethernet |
| replication | | | | |
| storage based | 1000 | DS8000 | 1 | Gigabit Ethernet |
| replication | | | | |

Once the PT computation is complete, the latency policy (LP) check is performed next in step 904 for one or multiple possible placement layouts with the database replication as placement technology—if there are different choices available. Please note that the latency policy is of particular interest for database replication technologies. The reason for this is that database replication technologies might have options for configuring the periodic cycle for the replication process from source to target systems. In addition, parameter setting may allow influencing the speed of extracting data units from the source and also parameters for influencing the speed of applying data units on the target system. For example, some database replication technologies allow for example to specify the number of capture agents (which track the changes on the production system which need to be replicated to the target system) and apply agents (which apply the replicated changes from the production system to the target system). Given sufficient network, CPU and IO bandwidth, increasing or decreasing the number of these agents allow to influence the transfer rate of this database replication technology. This increases or decreases the time each individual, periodical replication cycle needs to complete. Impact on the transfer rate by increasing or decreasing the number of agents in certain typical setups is stored as part of the placement technology information if the database replication technology has such options. Depending on the implementation of the database replication used, the impact on the production system may vary as well (for example, trigger based implementation versus log based implementations). Information about these configuration options is available from the placement technology information.

Also the expected amount of data changed between two replication cycles affects the overall time of an individual, periodic replication cycle. Using the same setup, this means the larger the delta of changes on data units between two replication cycles, the longer the replication cycle will need to complete. So if the latency is for example 30 minutes and the amount of data is sufficiently large so that a single replication would need more than 30 minutes to complete, obviously the setup needs to be changed in order to fulfil the latency. Since the delta of changes between two replication cycles might change over time and might be difficult to accurately predict, constant monitoring and eventually readjustments might be required. The readjustments (if needed) are computed by the information provisioning unit again. Based on this as background, latency means how much time might pass until a change on a data unit in the production database (the source) is replicated to the target database (located on the target system and also called a “replica”). If a replica is needed, there are three possible basic scenarios. As a first option, there is only one occurrence of a replication which replicates all data units required to the target system. In this case, latency does not matter because after this initial replication it does not matter if the data units change on the source. As a second option, there is a periodic replication required, which starts after the initial replication completed. As a third option, replication may be carried out on demand. The latency might influence the decision on the database replication technology selected for placing the data units if different choices are available.

If the SLA specifies parameters for data accurateness and latency, the information provisioning unit needs to compute the periodic replication schedule in order to fulfil these requirements in order to eventually trigger the setup of an appropriate database replication configuration. In computing the periodic replication schedule to fulfil the data accurateness and latency requirements, the information provisioning unit needs to consider, for example, the following items: available hardware; average amount of changes between two replication cycles; replication time needed for a certain amount of data in a given setup; and/or transfer rates of database replication technologies. The information provisioning unit computes the appropriate configuration for the database replication setup in an ongoing scenario based on this information.

Finally, the cost policy (CP), where the goal of the provisioning infrastructure is to make the information provisioning at as low cost as possible, is checked in step 905. Note that the currency Euro used for the discussion is an example. Depending on implementation, the currency can be any other currency as well as long as it is consistently used across CP computation. Relevant identifiers are the following. The cost of the hardware per week in use (CW) is measured in Euro/week. The duration (D) for which the hardware is required is measured in weeks. The maximum cost (MC) the customer is willing to pay for the service is in Euro. A hardware configuration is eligible for being used in the provisioning if the following condition is fulfilled: D*CW≦MC. For all hardware setups fulfilling the PT policy, the setup with minimal costs will be determined as optimization step by the information provisioning unit. In the context for this description, it is assumed that in the hardware configuration all costs for the IT service provider are included for the sake of simplicity of the description here. In reality, from the MC constraint other costs such as used software licenses and other things need to be deducted first before it can be checked if a set of hardware over a certain period is fulfilling the cost constraint. If the CP is fulfilled and the previously checked policies were fulfilled as well (meaning for example that a marker that the PT is broken was not set), then the applicable placement layout is added to the list of valid choices in step 906. If CP is not fulfilled, then the placement layouts considered are added to the list of invalid choices in step 908.

Continuing with the example above, the following costs would be available from the placement technology information for the two storage based replication hardware configurations fulfilling the PT policy: for ESS, CW=500 Euro/week and for DS8000, CW=1000 Euro/week. Assume further D=8 weeks and MC=5000 Euros. Thus only the storage based replication using ESS hardware fulfils the cost and provisioning time policies. If there would not be hardware available to fulfil in the desired timeslot the CP, then the closest alternative available would be shown and then the service consumer could decide if he accepts the closest alternative.

If a database replication is considered in step 810 of FIG. 8 to be the best choice for placing the data units, then the information provisioning unit first prepares through a handler 350 the appropriate setup and configuration for the deployment of the database replication as placement technology used in step 910. As last step, the information provisioning unit 421 then triggers execution and orchestration in step 911 through the handler 350 for the deployed setup of the database replication.

### Optimization Performed by the Application Deployment Unit

Many applications today have part of the application logic implemented in application units deployed and executed by the database server working on data units which belong to the overall application. Hence, solving the problem of providing in an efficient way the data units to an application is not enough by itself. The application units belonging to these data units need to be deployed and provided as well as needed by the application using them. For this purpose, the application deployment archive is introduced. It has typically an XML file containing information on the business process or service which represents the application. In addition, the XML file has information on the data units required by the application, as well as information on the required application units (triggers, stored procedures (SPs), user defined functions (UDFs)). In addition to the XML file, the source or binaries for the application units are typically included in the archive as well. The application deployment unit 422 in FIG. 3 is hence responsible for this task. The objective for the application deployment unit 422 is to provide an automated, transparent deploy- and undeployment process which orchestrates different deployment technologies depending on the interface of available database system implementations. The Deployer 370 in FIG. 2 is basically the adapter for the orchestration. The implementation of the application deployment unit 422 hence typically requires an adapter for each deployment technology that it needs to orchestrate (in case they require different interfaces). Conceptually similar to a “*.ear” file, which can be seamlessly deployed on a Web Application Server application, an application deployment archive concept is used along with a deployment mechanism (analogon). In such an archive, basically the following can be found: descriptor of the business process with all relevant information for provisioning and deployment; and all *.class, *.sql, and other such files which make up the application units.

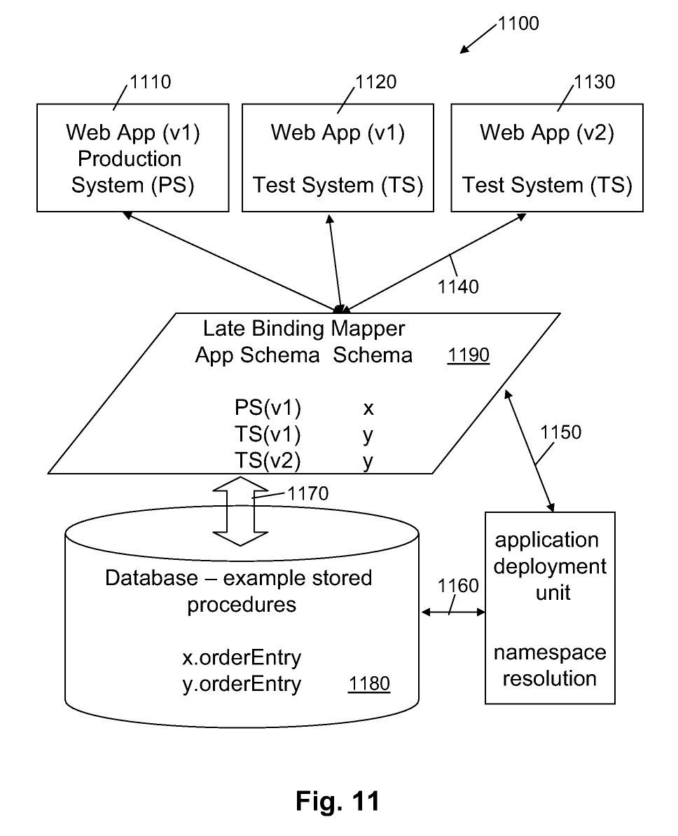

The application deployment unit 422 typically has to make sure that an application is using the right version of the data units and the application units. Referring as an example to a use case, where test against production data (see FIG. 11, 1110) is desirable, a new version of application units is to be tested, but the front end of the application may not have been changed for testing (see FIG. 11, 1120). In this case, the front end assumes that the application units are still available using the old names. However, since an application unit cannot be deployed twice on a database system with the same name, a naming conflict resolution for distinguishing between the old version application units (in production) and the new version application units (to be tested) needs to be available. The solution is to introduce an abstraction layer allowing namespace conflict resolution and late binding. The abstraction layer's main task is to do late binding for applications using application units such as SPs and UDFs, for example. The application uses a logical name for a stored procedure, and the late binding mapper (LBM, see FIG. 11, 1190) as abstraction layer between database and applications translates this logical name to the actual name in the database. Hence the late binding mapper allows execution of the desired version of an application unit by translating logical names 1140 on behalf of the applications to the real names in the database (1170). It is possible to have different versions of the same SP in the database, where one version is the production version and another version is the new version currently in testing phase. The production application (see FIG. 11, 1110) is able to use the production version of the SP in the namespace of schema x, whereas the same version of the application (1120) and as well as the new application version (see FIG. 11, 1130) can use the new version of the SP during tests with real production data in the namespace of schema y. The application deployment unit 422 will perform the namespace resolution and namespace conflict handling by interacting (1150) with the LBM. Performing these tasks, the application deployment unit 422 will interact with the LBM through an API for removing, inserting or updating namespace resolution rules used by LBM for transparent late binding of data units and application units. This requirement is closely related to metadata management. Once the namespace is resolved, the application deployment unit 422 orchestrates (1160) the deployment of application units through the Deployer 370 to the target database system(s) (1180) where the data units where placed.

In addition to the namespace resolution, also the application units need to be deployed. Here are three different major cases possible: a first option is new deployment of application units. The application units may be initially deployed using the provided deployment archive or by extraction from the production system. A second alternative is update of deployment, and a third alternative is removal of deployment.

An example for initial deployment using the deployment archive would be a scenario where, for example, for all application units from an online store, a new version should be tested against real production data on a separate test system. In this case, the application deployment archive would contain the version of all application units and the application deployment unit would trigger the deployment of them. FIG. 6 shows an application deployment archive where the flag for initial deployment is set to “yes”.

An example for initial deployment by extraction from the production system would be a scenario, where a new web front is supposed to be tested without any change in the application units. In this case, GIPDO would extract all the application units from the source system if needed, and triggers deployment on the target system used as test system. In this case the application deployment archive would not include the binaries and the application deployment unit would conclude from the absence of them that they need to be extracted along with the data units from the source system which is the production system.

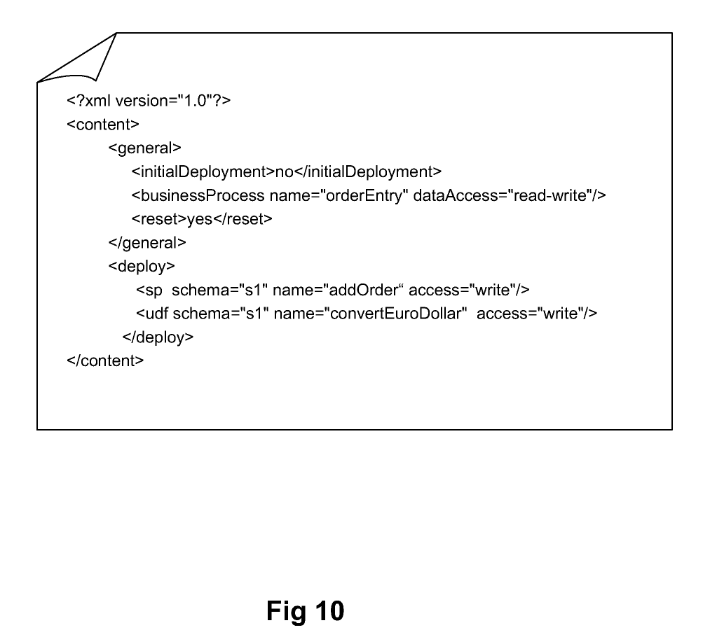

An example for update deployment would be if during a test of a new version of an application unit a bug would be discovered and a new version needs to be deployed. Then the application deployment unit would trigger the un-deployment of the version with the bug and then it would trigger the deployment of the new version. An application deployment archive for this case is shown in FIG. 10 where the flag for initial deployment is set to “no” and the reset flag is set to “yes” indicating that the data units on which the application units work should be refreshed to the initial status.

An example for remove deployment is obvious: Whenever the provisioned data units and the related application units are not needed any longer the application deployment unit needs to trigger the un-deployment.

### Implementation Considerations

GIPDO can be implemented as a Service according to a SOA-style architecture and design approach to be a reusable service in a dynamic IT infrastructure. In order to work with other components of a dynamic IT infrastructure, being compliant with relevant web service standards has to be part of the design of the GIPDO APIs.

The GIPDO implementation may be based on existing standard cost based optimization strategies. In addition to the information that is contained in the system catalog tables of the database, GIPDO may be mainly using information, which is stored in the repositories (examples mentioned above are the hardware status information and the placement technology information). Accessing information from repositories, and interpreting the given SLA, will allow GIPDO to decide on an optimized strategy and plan for autonomic provisioning and deployment. Similar to DB2 UDB evaluating several data access plans to decide on the most cost-effective access strategy, GIPDO will evaluate several provisioning and deployment alternatives, and will decide on the most cost effective strategy.

In doing so, GIPDO takes into account the characteristics of the business process or application (that is, “only” read or update/delete/insert statements), the SLA specifications (that is, cost, resilience specifications, and/or quality of data specifications, to name a few), available hardware resources (that is, available test server hardware), existing data placement and provisioning technologies (that is, placement technologies such as database replication, storage based replication), and other information or constraints, such as database application logic to be deployed, option to use the production server and data environment. Again, similar to the existing cost based optimization in relational databases (for example, in DB2 UDB) and global optimization in existing federation technologies (for example, in WebSphere Information Integrator), GIPDO decides on an optimum and most cost-effective information provisioning and deployment strategy. This strategy and plan is typically stored in a “Provisioning & Deployment” catalog of GIPDO for reference and query purposes.

Implementing the provisioning and deployment function is a translation of the GIPDO optimizer strategy in terms of orchestrating the existing placement and deployment technologies. This should be done by addressing the key design point in the GIPDO implementation design to allow for flexibility in terms of considering and integrating new data placement technologies from various vendors. In addition, SOA utility services (that is, metering and/or billing) may be called by GIPDO to monitor the adherence to the SLA specifications. Since GIPDO is orchestrating existing placement technologies, it may also allow for inclusion of future provisioning and deployment technologies beyond what is known today. This may require changes in the GIPDO optimization part and the GIPDO orchestration part.

Embodiments of the invention can take the form of an entirely hardware embodiment, an entirely software embodiment, or an embodiment containing both hardware and software elements. In a preferred embodiment, the invention is implemented in software. Furthermore, the invention can take the form of a computer program product accessible from a computer-usable on computer-readable medium providing program code for use by or in connection with a computer or any instruction execution system. For the purposes of this description, a computer-usable or a computer-readable medium can be any apparatus that can contain, store, communicate, propagate or transport the program for use by or in connection with the instruction execution system, apparatus or device. The medium can be an electronic, magnetic, optical, electromagnetic, infrared or semiconductor system (or apparatus or device) or a propagation medium.

The foregoing detailed description of embodiments of the invention is provided for the purposes of illustration and is not intended to be exhaustive or to limit the invention to the embodiments disclosed. The scope of the present invention is defined by the appended claims.

We claim:

1. A computerized method for providing data stored in a database within a data processing system to an application, the method comprising:
determining at least one criterion for providing data to the application from the data processing system based at least on a service level agreement;
receiving a provisioning and deployment description identifying at least data units of a database to be provided to the application;
maintaining a system description including status and resource usage information of a plurality of possible target systems within the data processing system;
receiving a placement technology description describing properties of a plurality of data placement technologies supported within the data processing system;
selecting at least one target system and at least one data placement technology based on said at least one criterion, said provisioning and deployment description, said system description and said placement technology description; and
providing access to said data units for said application using said selected at least one target database system and said at least one data placement technology.

2. A method as defined in claim 1, comprising using the selected at least one data placement technology to deploy the data units to said selected at least one target system.

3. A method as defined in claim 1, wherein said provisioning and deployment description further identifies at least one application unit executable by said database and associated with said data units, said method comprising providing access to said at least one application unit for said application.

4. A method as defined in claim 3, comprising deploying said at least one application unit to said selected at least one database system.

5. A method as defined in claim 3, comprising storing said at least one application unit in an application deployment archive together with said provisioning and deployment description.

6. A method as defined in claim 3, comprising receiving an updated version of an application unit associated with said application, storing said updated version in the application deployment archive, and updating said provisioning and deployment description to refer to the updated version of the application unit.

7. A method as defined in claim 3, wherein said at least one application unit comprises at least one of the following: computer executable code in compiled form, computer executable code in source form.

8. A method as defined in claim 3, comprising
receiving a logical name of an application unit from said application,
binding said logical name to an executable application unit based on said provisioning and deployment description, and
executing the deployment of the respective executable application unit in said selected at least one target database system.

9. A method as defined in claim 1, wherein said plurality of data placement technologies comprises at least one of the following data placement technologies: direct read, materialized query tables, database replication, and storage replication.

10. A data processing program product for execution in a data processing system, said computer program product comprising software code portions for performing a method according to claim 1 when said data processing program product is loaded in said data processing system.

11. A data processing program product as defined in claim 10, embodied in a computer readable medium.

12. A data processing system comprising
a plurality of database systems for storing data units;
a placement technology description describing properties of a plurality of data placement technologies supported by the data processing system;
at least one interface for receiving
service level agreements associated with applications, and
provisioning and deployment descriptions identifying at least data units associated with respective application units, and
a controller configured to carry out a method as defined in claim 1 for providing access to data stored within the data processing system to an application.

13. A data processing system as defined in claim 12, comprising at least one server for running said applications.

14. A data processing system as defined in claim 12, wherein said provisioning and deployment description identify application units associated with respective applications, and the data processing system comprises storage facilities for storing said application units executable by said database systems.

15. A data processing system as defined in claim 12, wherein said controller comprises a data processing program installed on the data processing system.
